(19) United States
(12) Patent Application Publication
(10) Pub. No.: US 2026/0258215 A1
(43) Pub. Date: Sep. 3, 2026

(54) Polyamide Aerogel and Preparation Method Therefor

(71) Applicant: Microvast Advanced Membranes Inc., Lake Mary, FL (US)

(72) Inventors: Haipeng ZHANG, Huzhou (CN); Jinbo HE, Huzhou (CN); Jianzhao LIU, Lake Mary, FL (US); Wenjuan Liu MATTIS, Stafford, TX (US)

(73) Assignee: Microvast Advanced Membranes Inc., Lake Mary, FL (US)

(21) Appl. No.: 19/066,991

(22) Filed: Feb. 28, 2025

(51) Int. Cl. C08J 9/28; C08G 69/28; C08G 69/32; C08J 3/075

(52) U.S. Cl. CPC C08J 9/283; C08G 69/28; C08G 69/32; C08J 3/075; C08J 2201/0504; C08J 2205/026; C08J 2377/06

(57) ABSTRACT

Polyamide aerogel and preparation method therefor are provided. The polyamide aerogel is a porous material, a porosity of the polyamide aerogel is 90-99%, and a thermal conductivity of the polyamide aerogel is less than or equal to 0.048 W/(m·K). The polyamide aerogel of the present disclosure is a porous material. The polyamide aerogel with a high porosity provides more adsorption surface area and volume, such that more active sites may be provided to the polyamide aerogel, thereby improving the adsorption capacity and catalytic activity of a material, and thus, the polyamide aerogel is suitable for air purification, wastewater treatment, and as a catalyst carrier. An extremely low thermal conductivity (less than or equal to 0.048 W/(m·K)) facilitates insulation and heat preservation. Furthermore, the polyamide aerogel has a desirable structure and mechanical property and thus is more suitable for the fields of architecture, aerospace, and energy storage.

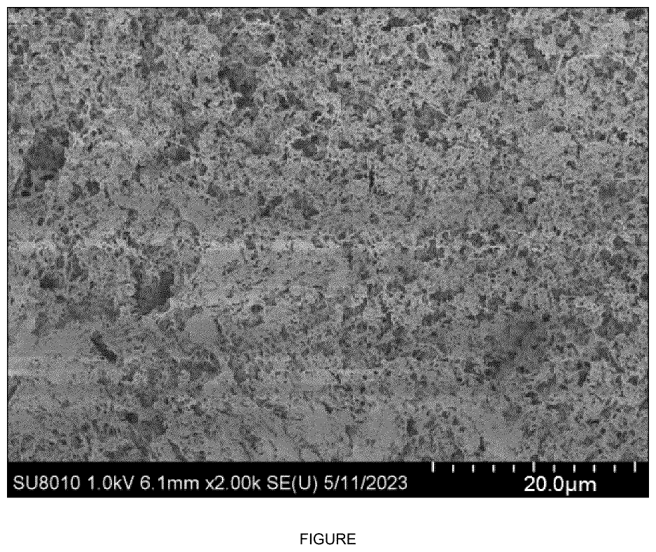

### TECHNICAL FIELD

The present disclosure relates to the technical field of aerogel, and specifically, to polyamide aerogel and preparation method therefor.

### BACKGROUND

Aerogel has the characteristics of being high in specific surface area, high in porosity, low in density, and high in adsorbability. Therefore, the aerogel has wide application prospects in the fields such as energy conservation and environmental protection, biomedicine, aerospace, and building insulation materials. Since the first aerogel was prepared by the professor Kistler, the aerogel has become a hot material for scholars to study nowadays, and various types of inorganic aerogel, organic aerogel, and inorganic/organic composite aerogel have been successfully developed. However, methods for preparing a polyamide aerogel suitable for industrialization have not been publicly reported at present.

### SUMMARY

The present disclosure is mainly intended to provide polyamide aerogel and preparation method therefor.

In order to implement the above objectives, an aspect of the present disclosure provides a polyamide aerogel. The polyamide aerogel is a porous material. A porosity of the polyamide aerogel is 90%-99%, and a thermal conductivity of the polyamide aerogel is less than or equal to 0.048 W/(m·K).

As an implementation, a specific surface area of the polyamide aerogel is 200 m²/g-450 m²/g.

As an implementation, an average pore diameter of pores of the polyamide aerogel is 1 nm-10 nm; and/or a density of the polyamide aerogel is 1 mg/cm³-50 mg/cm³.

Another aspect of the present disclosure provides a method for preparing the polyamide aerogel. The preparation method includes: at step S1, a complex reaction is performed on a raw material including a polyamide slurry and a coordination crosslinking agent, to obtain a composite; at step S2, a gelation reaction is performed on the composite and a gelation reagent, to obtain a gelation product; at step S3, a solvent displacement treatment is performed on the gelation product, to obtain a polyamide wet gel; and the step S4, a drying treatment is performed on the polyamide wet gel to obtain the polyamide aerogel.

As an implementation, in step S1, a mass ratio of polyamide in the polyamide slurry to the coordination crosslinking agent is 1:0.032-0.8.

As an implementation, polyamide in the polyamide slurry is aromatic polyamide, and/or the aromatic polyamide is selected from any one or more of poly(p-phenylene terephthamide), poly(m-phenylene isophthalamide), poly(p-benzamide), and polyphenylsulfone terephthalamide.

As an implementation, in step S1, a temperature of the complex reaction is 5° C.-60° C.; and/or a time for the complex reaction is 0.3 h-33 h.

As an implementation, the polyamide slurry includes polyamide and a first solvent; and the first solvent is selected from any one or more of dimethyl sulfoxide, N,N-dimethylformamide, N,N-Dimethylacetamide, N,N-dimethylhexanamide, N-methylpyrrolidone, and triethyl phosphate.

As an implementation, a solid content of the polyamide slurry is 1%-10%, and/or a pH value of the polyamide slurry is 4-7.

As an implementation, in step S1, the coordination crosslinking agent includes an inorganic copper salt and/or an inorganic nickel salt.

As an implementation, in step S1, the inorganic copper salt is selected from any one or more of copper chloride, copper fluoride, and copper bromide.

As an implementation, in step S1, the inorganic copper salt includes an inorganic copper salt powder or an inorganic copper salt solution, the inorganic copper salt solution includes an inorganic copper salt and a second solvent, and a mass ratio of the inorganic copper salt to the second solvent is 10-20:5-10.

As an implementation, in step S1, the inorganic nickel salt is selected from any one or more of nickel chloride, nickel fluoride, and nickel bromide.

As an implementation, in step S2, a temperature of the gelation reaction is 5° C.-60° C.; and/or a time for the gelation reaction is 3 h-30 h.

As an implementation, in step S2, the gelation reaction is performed under a condition of high-speed shear dispersion, and a rotary speed of high-speed shear dispersion is 50 rpm-5000 rpm.

As an implementation, in step S2, a solid content of the gelation product is 1%-10%.

As an implementation, in step S2, the gelation reagent is selected from any one or more of water, an aqueous solution containing 20 wt. %-50 wt. % of N,N-dimethylacetamide, hydrochloric acid, sulfuric acid, ethanol, ethylene glycol, glycerol, acetone, tetrahydrofuran, chloroform, dichloromethane, and glacial acetic acid.

Further, in step S4, the drying treatment includes performing vacuum freeze drying and/or vacuum drying on the polyamide wet gel; the vacuum freeze drying process includes: temperature holding is performed on the polyamide wet gel for 4 h-10 h at −40° C. to −20° C., and then under a vacuum condition, temperature holding for 4 h-10 h at −20° C. to −10° C., temperature holding for 4 h-10 h at −10° C. to 0° C., and temperature holding for 4 h-10 h at 0° C. to 10° C. are successively performed on the polyamide wet gel, where the vacuum condition means that a gas pressure is less than 10 Pa.

As an implementation, the vacuum drying process includes: the polyamide wet gel is dried for 6 h-10 h at 50° C.-80° C. and the gas pressure less than 10 Pa.

As an implementation, the polyamide slurry is an aromatic polyamide slurry. The preparation method further includes a process of preparing the aromatic polyamide slurry.

The preparation process includes: an amidation reaction is performed on a raw material including aromatic diacyl chloride, aromatic diamine, and a fourth solvent, to obtain an aromatic amidation product; a neutralization treatment is performed on the aromatic amidation product by using an alkaline reagent, to obtain a neutralized product; a dilution treatment is performed on the neutralized product by using the fourth solvent, to obtain the aromatic polyamide slurry; or polyamide is dissolved in a fifth solvent to obtain the aromatic polyamide slurry.

By using the technical solutions of the present disclosure, the polyamide aerogel of the present disclosure is a porous material. The polyamide aerogel with a high porosity provides more adsorption surface area and volume, such that more active sites may be provided to the polyamide aerogel, thereby improving the adsorption capacity and catalytic activity of a material, and thus, the polyamide aerogel is suitable for air purification, wastewater treatment, and as a catalyst carrier. At an extremely low thermal conductivity (less than or equal to 0.048 W/(m·K)), a thermal conductivity coefficient of the polyamide aerogel in some embodiments of the present disclosure may even reach 0.025 W/(m·K), thereby facilitating insulation and heat preservation. Furthermore, the polyamide aerogel has a desirable structure and mechanical property and thus is more suitable for the fields of architecture, aerospace, and energy storage.

### BRIEF DESCRIPTION OF THE DRAWINGS

The drawings, which form a part of the present disclosure, are used to provide a further understanding of the present disclosure. The exemplary embodiments of the present disclosure and the description thereof are used to explain the present disclosure, but do not constitute improper limitations to the present disclosure. In the drawings:

The FIGURE shows a Scanning Electron Microscope (SEM) diagram of an aramid aerogel obtained in Embodiment 1 of the present disclosure.

### DETAILED DESCRIPTION OF THE EMBODIMENTS

It is to be noted that the embodiments in the present disclosure and the features in the embodiments may be combined with one another without conflict. The present disclosure will be described below in detail with reference to the drawings and the embodiments.

As analyzed in the Background of the present disclosure, there are problems in the related art, and in order to solve the problems, the present disclosure provides polyamide aerogel and preparation method therefor.

A typical implementation of the present disclosure provides a polyamide aerogel. The polyamide aerogel is a porous material. A porosity of the polyamide aerogel is 90%-99%, and a thermal conductivity of the polyamide aerogel is less than or equal to 0.048 W/(m·K).

The polyamide aerogel of the present disclosure is a porous material. The polyamide aerogel with a high porosity provides more adsorption surface area and volume, such that more active sites may be provided to the polyamide aerogel, thereby improving the adsorption capacity and catalytic activity of a material, and thus, the polyamide aerogel is suitable for air purification, wastewater treatment, and as a catalyst carrier. At an extremely low thermal conductivity (less than or equal to 0.048 W/(m·K)), in some embodiments, a thermal conductivity coefficient of the polyamide aerogel may even reach 0.025 W/(m·K), thereby facilitating insulation and heat preservation. Furthermore, the polyamide aerogel has a desirable structure and mechanical property and thus is more suitable for the fields of architecture, aerospace, and energy storage.

In some embodiments of the present disclosure, a specific surface area of the polyamide aerogel is 200 m²/g-450 m²/g.

The polyamide aerogel has a large specific surface area, such that more active sites can be provided for the application of the polyamide aerogel such as adsorption, catalysis, energy storage, etc., thereby improving the overall performance of the polyamide aerogel. The specific surface area of the polyamide aerogel may be 200 m²/g-450 m²/g, or 210 m²/g-440 m²/g, or 220 m²/g-420 m²/g, or 250 m²/g-400 m²/g, or 280 m²/g-350 m²/g, or 300 m²/g-380 m²/g, or 330 m²/g-350 m²/g. The polyamide aerogel having the above specific surface area has a large number of pores inside, such that a thermal conductivity coefficient of the polyamide aerogel is greatly reduced, thereby improving thermal insulation performance.

In some embodiments of the present disclosure, an average pore diameter of pores of the polyamide aerogel is 1 nm-10 nm; and/or a density of the polyamide aerogel is 1 mg/cm³-50 mg/cm³.

The average pore diameter of the pores of the polyamide aerogel may be 1 nm-10 nm, or 3 nm-6 nm. By controlling the density of the polyamide aerogel within the above range, a lightweight advantage is given to the polyamide aerogel. The density of the polyamide aerogel may be 1 mg/cm³-50 mg/cm³, or 5 mg/cm³-45 mg/cm³, or 15 mg/cm³-35 mg/cm³, or 20 mg/cm³-30 mg/cm³. Polyamide aerogel is a non-vacuum thermal insulation material (porous material), which mainly plays a role in inhibiting heat conduction. A combination of low density and small pores makes the aerogel have a relatively low thermal conductivity. Further, polyamide itself has good heat-resistant properties, such that the polyamide aerogel may have great application prospects in the field of thermal insulation, aerospace, environmental protection, and energy conversion.

Another typical implementation of the present disclosure provides a method for preparing the polyamide aerogel. The preparation method includes: at step S1, a complex reaction is performed on a raw material including a polyamide slurry and a coordination crosslinking agent, to obtain a composite; at step S2, a gelation reaction is performed on the composite and a gelation reagent, to obtain a gelation product; at step S3, a solvent displacement treatment is performed on the gelation product, to obtain a polyamide wet gel; and step S4, a drying treatment is performed on the polyamide wet gel to obtain the polyamide aerogel.

The polyamide itself has good heat-resistant properties. The preparation method uses the polyamide slurry as a wet raw material. An acting force is generated between polyamide molecules by using a coordination complex effect of metal ions in the coordination crosslinking agent on the polyamide molecules, to form the three-dimensional structure composite having pores, such that a pore structure of the final polyamide aerogel is greatly fundamentally enriched, the average pore diameter of the pores of the polyamide aerogel is reduced, the thermal conductivity of the polyamide aerogel is reduced, and the porosity of the polyamide aerogel is increased. The polyamide aerogel has a desirable structure and mechanical property, and heat resistance, such that the application range of the polyamide aerogel is widened, and thus the polyamide aerogel is more suitable for being used in the field of thermal insulation. The three-dimensional structure of the composite is immobilized by the gelation reaction, such that the structure of the obtained polyamide aerogel is prevented from collapsing. Solvents and moisture left in the polyamide aerogel are further removed through the solvent displacement treatment and the drying treatment, such that the stability of the polyamide aerogel is improved. In addition, compared with traditional preparation methods, the preparation method is simple, efficient, low in energy consumption, and low in cost, such that large-scale mass production may be realized, thereby enlarging the application range of the polyamide aerogel.

In some embodiments of the present disclosure, in step S1, a mass ratio of polyamide in the polyamide slurry to the coordination crosslinking agent is 1:0.032-0.8.

If the mass ratio of the polyamide in the polyamide slurry to the coordination crosslinking agent is <1:0.8, cross-linking ions participating in the reaction are increased, leading to a reduction in a specific surface area of a product and an increase in the density, thus affecting the heat-insulating property of the polyamide aerogel. If the mass ratio of the polyamide in the polyamide slurry to the coordination crosslinking agent is >1:0.032, the generation of the composite with a stable structure is not facilitated, easily leading to collapse of the structure of the composite during drying, an reduction in the specific surface area of the polyamide aerogel, and an increase in the density, thus affecting the heat-insulating property of the polyamide aerogel. Therefore, in some implementations, the mass ratio of the polyamide in the polyamide slurry to the coordination crosslinking agent is within the above range, such that actual reaction concentrations of the polyamide slurry and coordination crosslinking agent are controlled, thereby maximally improving the efficiency and effect of the complex reaction, to cause the obtained composite to have a higher porosity. Furthermore, the mass ratio of the polyamide in the polyamide slurry to the coordination crosslinking agent may be 1:0.08-0.15, or 1:0.15-0.32, or 1:0.32-0.5, or 1:0.5-0.8.

In some embodiments of the present disclosure, polyamide in the polyamide slurry is aromatic polyamide, and/or the aromatic polyamide is selected from any one or more of poly(p-phenylene terephthamide), poly(m-phenylene isophthalamide), poly(p-benzamide), and polyphenylsulfone terephthalamide.

By selecting the above type of the aromatic polyamide, in one aspect, coordination may be better performed with metal ions in the coordination crosslinking agent, to form a stable nanoporous network; and in another aspect, the universality of the polyamide slurry is improved and types of the polyamide aerogel obtained by the method are further enriched.

In some embodiments of the present disclosure, in step S1, a temperature of the complex reaction is 5° C.-60° C.; and/or a time for the complex reaction is 0.3 h-33 h.

If the temperature of the complex reaction is lower than 5° C., production efficiency is affected, thereby increasing manufacturing costs. If the temperature of the complex reaction is higher than 60° C., a cross-linking reaction occurs quickly, and the structure of the obtained composite is not uniform enough, leading to a reduction in the specific surface area and an increase in the density, thus affecting heat-insulating property. In some embodiments of the present disclosure, the time for the complex reaction is 0.3 h-33 h, both the efficiency and effect of the complex reaction are taken into consideration. Further, the time for the complex reaction may be 0.3 h-33 h, or 1 h-30 h, or 1 h-25 h, or 1 h-10 h, or 3 h-6 h.

In some embodiments of the present disclosure, the polyamide slurry includes polyamide and a first solvent; and the first solvent is selected from any one or more of dimethyl sulfoxide, N,N-dimethylformamide, N,N-Dimethylacetamide, N,N-dimethylhexanamide, N-methylpyrrolidone, and triethyl phosphate.

The first solvent is conductive to improving the mixing uniformity of the polyamide slurry and the coordination crosslinking agent, thereby improving the efficiency and effect of the complex reaction.

In some embodiments of the present disclosure, a solid content of the polyamide slurry is 1%-10%, and/or a pH value of the polyamide slurry is 4-7.

Within the pH value range, the polyamide slurry is conductive to improving a synergistic complexing effect between the metal ions in the coordination crosslinking agent and the polyamide molecules, and side reactions such as precipitation of the metal ions in the coordination crosslinking agent are minimized. The pH value of the polyamide slurry may also be 4-5; and when the pH value is 4-5, the complex reaction is better in effect.

In some embodiments of the present disclosure, in step S1, the coordination crosslinking agent includes an inorganic copper salt and/or an inorganic nickel salt.

In the present disclosure, a stable complexing structure is formed through the coordination of copper ions and/or nickel ions (carrying excess electron pairs) in the coordination crosslinking agent and amide bonds in the polyamide molecules. By using such characteristics, physical cross-linking may be performed on a polyamide molecule chain, to prepare the polyamide aerogel. The polyamide aerogel prepared by the method has a stable nanoporous network structure, and high mechanical strength and thermal stability, pore collapse is avoided, and an aerogel with a high porosity and large specific surface area is prepared. Moreover, by using the above type of the coordination crosslinking agent, a protective gas is not required to prevent oxidation of the metal ions, and the reaction may be performed in an air atmosphere, such that process flows are simplified, costs are reduced, and the preparation process is more economical and environmentally-friendly, thereby facilitating the possibility of large-scale production of the polyamide aerogel. Furthermore, by using the above type of the coordination crosslinking agent, the efficiency of the complex reaction and the stability of the composite are improved, thereby improving the subsequent forming performance of the polyamide aerogel.

In some embodiments of the present disclosure, in step S1, the inorganic copper salt is selected from any one or more of copper chloride, copper fluoride, and copper bromide. The inorganic copper salt may be an inorganic copper salt powder or may also be an inorganic copper salt solution. The inorganic copper salt solution includes an inorganic copper salt and a second solvent, and a mass ratio of the inorganic copper salt to the second solvent is 10-20:5-10.

In some embodiments of the present disclosure, in step S1, the inorganic nickel salt is selected from any one or more of nickel chloride, nickel fluoride, and nickel bromide. The inorganic nickel salt may be an inorganic nickel salt powder or may also be an inorganic nickel salt solution. The inorganic nickel salt solution includes an inorganic nickel salt and a third solvent, and a mass ratio of the inorganic nickel salt to the second third is 10-20:5-10.

In some embodiments of the present disclosure, in step S1, the second solvent and the third solvent are each independently selected from any one or more of water, methanol, ethanol, and acetic acid, and the second solvent and the third solvent may be the same or different.

By controlling a mass ratio of the coordination crosslinking agent to a solvent within the above range, the coordination crosslinking agent may be promoted to be fully dissolved in the solvent, to form a uniform solution. Such uniformity is conductive to performing an effective complex reaction on the copper ions/nickel ions in the coordination crosslinking agent and the polyamide molecules, and a formation process of an aerogel structure is optimized. Water, methanol, ethanol, or acetic acid is selected as the solvent, which has good compatibility with the polyamide and the copper ions/nickel ions, and is relatively stable under a reaction condition, such that the stability of the coordination crosslinking agent is improved, and the risks of the side reactions are reduced, thereby improving the purity and quality of the aerogel. Furthermore, compared to some organic solvents, these solvents are lower in cost, and more friendly in environmental impact. Meanwhile, these solvents are easy to recycle and treat, thereby reducing resource consumption and waste discharge during production. By assigning the selection and mass ratio of the solvents, the uniformity of a reaction system may be promoted, and uneven reactions due to local concentration differences are reduced, such that the copper ions/nickel ions are uniformly distributed in a polyamide matrix, to form a more uniform pore structure.

In some embodiments of the present disclosure, in step S2, a temperature of the gelation reaction is 5° C.-60° C.; and/or a time for the gelation reaction is 3 h-30 h.

Furthermore, the above temperature and time for the gelation reaction are conductive to facilitating a uniform chemical reaction during gelation, to reduce the risks of localized overheating or insufficient reaction, thereby forming a gelation product with a uniform structure, and at the same time, an excellent pore structure, stability, and mechanical strength of the gelation product are maintained. Meanwhile, by selecting the above temperature and time for the gelation reaction, the occurrence of the side reactions is reduced, thereby improving the purity and quality of the finally obtained polyamide aerogel.

In some embodiments of the present disclosure, in step S2, the gelation reaction is performed under a condition of high-speed shear dispersion, and a rotary speed of high-speed shear dispersion is 50 rpm-5000 rpm.

The polyamide composite is exchanged with the gelation reagent during the gelation reaction, and by performing the gelation reaction under a condition of high-speed shear dispersion, the efficiency is greatly improved, and manufacturing costs are reduced. Specifically, if a rotary speed of high-speed shear dispersion is too small, a solvent exchange rate is slowed down, the gelation time is prolonged, production efficiency is low, and costs are high; and if the rotary speed of high-speed shear dispersion is too large, a shear force is too large, which easily damages the structure after gelation, thus leading to a performance loss of the polyamide aerogel. Therefore, the rotary speed of high-speed shear dispersion is within the above range, the polyamide composite is rapidly dispersed in the gelation reagent, to perform solvent exchange rapidly, thereby greatly improving the production efficiency. The rotary speed of high-speed shear dispersion may be 50 rpm-5000 rpm, or 500 rpm-4500 rpm, or 1000 rpm-4000 rpm, or 2000 rpm-4000 rpm.

In some embodiments of the present disclosure, in step S2, a solid content of the gelation product is 1%-10%.

Excessively high solid content of the gelation product leads to pore collapse or structural densification, and excessively-low solid content of the gelation product may cause the wet gel structure to be too loose, affecting the shape and performance of a material during subsequent drying. Therefore, by selecting the solid content of the gelation product within the above range, a ratio of a solid component in the gelation product to the solvent is appropriate, such that the shape of the pores of the wed gel is controlled more easily in the subsequent solvent displacement and drying steps, thereby facilitating the maintenance of the stability of the pore structure of the wet gel.

In some embodiments of the present disclosure, in step S2, the gelation reagent is selected from any one or more of water, an aqueous solution containing 20 wt. %-50 wt. % of N,N-dimethylacetamide, hydrochloric acid, sulfuric acid, ethanol, ethylene glycol, glycerol, acetone, tetrahydrofuran, chloroform, dichloromethane, and glacial acetic acid. Therefore, the efficiency and effect of a gelation process are improved.

In some embodiments of the present disclosure, in step S3, the number of times for the solvent displacement treatment is 3 times-10 times, and/or the time for the solvent displacement treatment is 2 h/time-4 h/time.

The solvent displacement treatment is intended to remove the solvents (the solvents introduced by the polyamide slurry) left in the polyamide aerogel, to conveniently perform the subsequent step of the drying treatment. The removal efficiency and effect of the solvents left in the polyamide aerogel are improved by controlling the number of times of the solvent displacement treatment and the time for each solvent displacement treatment within the above range.

In some embodiments of the present disclosure, in step S4, the drying treatment includes performing vacuum freeze drying and/or vacuum drying on the polyamide wet gel; the vacuum freeze drying process includes: temperature holding is performed on the polyamide wet gel for 4 h-10 h at −40° C. to −20° C., and then under a vacuum condition, temperature holding for 4 h-10 h at −20° C. to −10° C., temperature holding for 4 h-10 h at −10° C. to 0° C., and temperature holding for 4 h-10 h at 0° C. to 10° C. are successively performed on the polyamide wet gel, where the vacuum condition means that a gas pressure is less than 10 Pa.

The vacuum-freeze drying treatment facilitates the removal of excess moisture in the polyamide wet gel. The removal principle is to sublimate the water and remove it as gaseous water, such that an impact on a three-dimensional structure of the polyamide wet gel is reduced. The above vacuum freeze drying process with step-by-step temperature rising more facilitates the thorough removal of the moisture in the polyamide wet gel, and the shrinkage of the polyamide wet gel and damages to the pore structure are effectively reduced, and the moisture in the polyamide wet gel is removed at the same time, thereby forming the stable polyamide aerogel.

In some embodiments of the present disclosure, the vacuum drying process includes: the polyamide wet gel is dried for 6 h-10 h at 50° C.-80° C. and the gas pressure less than 10 Pa.

The solvents (the solvents introduced by the polyamide slurry) left in the polyamide wet gel are further removed through the vacuum drying treatment; and the removal principle is to vaporize the solvents and remove the solvents as gases. Through the drying treatment process, the moisture in the polyamide aerogel and other left solvents are removed more completely, such that the storage stability and performance stability of the polyamide aerogel are ensured.

Furthermore, by selecting an environmentally friendly solvent and optimizing the above drying process, the polyamide aerogel having a small impact on environments may be prepared, which conforms to current requirements for green manufacturing and sustainable development.

In some embodiments of the present disclosure, the polyamide slurry is an aromatic polyamide slurry. The preparation method further includes a process of preparing the aromatic polyamide slurry. The preparation process includes: an amidation reaction is performed on a raw material including aromatic diacyl chloride, aromatic diamine, and a fourth solvent, to obtain an aromatic amidation product. The polyamide slurry is more suitable for coordination with the metal ions (nickel/copper ions), and side reactions such as precipitation of the metal ions are minimized. A neutralization treatment is performed on the aromatic amidation product by using an alkaline reagent, to obtain a neutralized product; a dilution treatment is performed on the neutralized product by using the fourth solvent, to obtain the aromatic polyamide slurry; or polyamide is dissolved in a fifth solvent to obtain the aromatic polyamide slurry. Therefore, the viscosity and concentration are more suitable for the complex reaction of the metal ions. In addition, the temperature of the amidation reaction is −40° C. to 40° C., or −20° C. to 0° C. The amidation reaction is performed under the condition of a stirring rate being 100 r/min-800 r/min, such that the efficiency and effect of the amidation reaction are controlled more conveniently.

In some embodiments of the present disclosure, a mass ratio of the aromatic diacyl chloride to the fourth solvent is 10-30: 45-135, and/or a mass ratio of the aromatic diamine to the fourth solvent is 5-15:45-135, such that the aromatic diacyl chloride and the aromatic diamine are reacted more thoroughly. As an implementation, a substituent position relationship between acyl chlorine substituents on the aromatic diacyl chloride and a substituent position relationship between amino groups on the aromatic diamine are the same. For example, when two acyl chloride groups are in a meta-position, two amino groups are also in the meta-position, such that the obtained polyamide slurry reacts better in the subsequent complex reaction, thereby causing the porosity of the obtained polyamide aerogel to be higher; and/or the fourth solvent and the fifth solvent are respectively independently selected from any one or more of dimethyl sulfoxide, N,N-dimethylformamide, N,N-dimethylacetamide, N,N-dimethylhexanamide, N-methylpyrrolidone, and triethyl phosphate, facilitating dissolution and uniform mixing of the aromatic diacyl chloride and the aromatic diamine, thereby improving reaction efficiency.

In some embodiments of the present disclosure, the solid content of the neutralized product is 10%-30%, and/or the using amount of the alkaline reagent is 1%-5% of the total mass of the amidation product. In some implementations, the alkaline reagent is selected from any one or more of potassium hydroxide, sodium hydroxide, calcium hydroxide, sodium tert-butoxide, potassium tert-butoxide, potassium bis(trimethylsilyl)amide, sodium bis(trimethylsilyl)amide, potassium ethoxy, triethylamine, tetramethylethylene diamine, sodium hydride, and potassium hydride. Therefore, the pH value of the amidation product is adjusted to an appropriate range, causing the amidation product to perform the complex reaction with the metal ions more easily.

The present disclosure is further described in detail below with reference to specific embodiments, and the embodiments cannot be construed as limiting the scope of protection claimed in the present disclosure.

### Embodiment 1

At step S1, 205.23 g of isophthaloyl dichloride and 108.14 g of m-phenylenediamine were dissolved in 900 g of N,N-dimethylacetamide, stirred at a temperature of −20° C. and a speed of 400 r/min, and synthesized into an aramid slurry 1 through a reaction, then calcium hydroxide was added to regulate a pH value of the aramid slurry 1 to 5, then a N,N-dimethylacetamide solution was added, an aramid slurry 2 was obtained after dilution, and a solid content of the aramid slurry 2 was 3.75 wt %.

At step S2, 3200 g of the aramid slurry 2 was taken and put in a reactor, and 20 g of CuCl₂ and 600 g of H₂O were added to a beaker for stirring and dissolving, to obtain a CuCl₂ solution. The aramid slurry was stirred at 600 r/min, the CuCl₂ solution was slowly added, stirring was performed for 0.5 h until a uniform solution was formed, and the solution was allowed to stand for 6 h at 45° C., to form an aramid composite. The aramid composite was taken and placed in a 40 wt. % N,N-dimethylacetamide solution (40% of the N,N-dimethylacetamide and 60% of water), high-speed shear dispersion and filtration were performed at 45° C., and repeated for three times, to obtain a gelation product, where a rotary speed of high-speed shear dispersion was 3000 rpm.

At step S3, the gelation product was taken and added to a tert-butanol solvent for a solvent displacement treatment, the tert-butanol solvent was changed every 4 h, and this operation was repeated for 4 times, to obtain an aramid wet gel.

At step S4, the aramid wet gel was taken, vacuum freeze drying was performed; and then vacuum drying was performed. A specific operation of vacuum freeze drying included: the aramid wet gel was subjected to continuous temperature holding at −20° C. for 4 h, then vacuuming was performed until a vacuum degree was 0.5 Pa, the vacuum degree was held, the temperature was heated to −10° C., and the temperature was held for 4 h; then the temperature was heated to 0° C., and the temperature was held for 4 h; then the temperature was heated to 10° C., and the temperature was held for 4 h; and the mixture was taken out after the reaction ended, to obtain an aramid aerogel after vacuum freeze drying. The vacuum drying operation specifically included: an oven was vacuumed until the vacuum degree was 0.5 Pa, the temperature of an oven was set to 100° C., and the aramid aerogel after vacuum freeze drying was dried for 6 h under such conditions; and the aramid aerogel was finally obtained. The FIGURE was an SEM diagram of the aramid aerogel obtained in Embodiment 1.

### Embodiment 2

The difference between this embodiment and Embodiment 1 lies in that, the rotary speed of high-speed shear dispersion in step S2 was 2000 rpm, to finally obtain the aramid aerogel.

### Embodiment 3

The difference between this embodiment and Embodiment 1 lies in that, the rotary speed of high-speed shear dispersion in step S2 was 600 rpm, to finally obtain the aramid aerogel.

### Embodiment 4

The difference between this embodiment and Embodiment 1 lies in that, the rotary speed of high-speed shear dispersion in step S2 was 5000 rpm, to finally obtain the aramid aerogel.

### Embodiment 5

The difference between this embodiment and Embodiment 1 lies in that, the rotary speed of high-speed shear dispersion in step S2 was 50 rpm, to finally obtain the aramid aerogel.

### Embodiment 6

The difference between this embodiment and Embodiment 1 lies in that, in step S2, the aramid composite was formed through the complex reaction by performing standing for 15 h at 50° C., to finally obtain the aramid aerogel.

### Embodiment 7

The difference between this embodiment and Embodiment 1 lies in that, in step S2, the aramid composite was formed through the complex reaction by performing standing for 0.3 h at 60° C., to finally obtain the aramid aerogel.

### Embodiment 8

The difference between this embodiment and Embodiment 1 lies in that, in step S2, the aramid composite was formed through the complex reaction by performing standing for 33 h at 5° C., to finally obtain the aramid aerogel.

### Embodiment 9

The difference between this embodiment and Embodiment 1 lies in that, in step S1, the solid content of the diluted aramid slurry 2 was 1%, to finally obtain the aramid aerogel.

### Embodiment 10

The difference between this embodiment and Embodiment 1 lies in that, in step S1, the solid content of the diluted aramid slurry 2 was 10%, to finally obtain the aramid aerogel.

### Embodiment 11

The difference between this embodiment and Embodiment 1 lies in that, in step S2, a mass ratio of aramid in the aramid slurry 2 to CuCl₂ was 1:0.032, to finally obtain the aramid aerogel.

### Embodiment 12

The difference between this embodiment and Embodiment 1 lies in that, in step S2, a mass ratio of aramid in the aramid slurry 2 to CuCl₂ was 1:0.8, to finally obtain the aramid aerogel.

### Embodiment 13

The difference between this embodiment and Embodiment 1 lies in that, in step S2, the coordination crosslinking agent was replaced from CuCl₂ to NiCl₂, and a mass ratio of aramid in the aramid slurry 2 to NiCl₂ was 1:0.17, to finally obtain the aramid aerogel.

### Performance Test:

A BET test method was used to test the specific surface area and average pore diameter of the aramid aerogel obtained in the embodiments (an instrument was a specific surface and pore diameter analyzer, supplier: Hangzhou Neoline Technology Co., Ltd., specification and model: JW-BK-400).

A thermal conductivity coefficient of the aramid aerogel obtained in the embodiments was determined by using a test method for thermal conductivity coefficient of nonmetal solid materials by hot-wire method (GB/Ti0297-2015).

Test results were shown in Table 1 below, which respectively indicated data on the specific surface area, average pore diameter of pores, and thermal conductivity coefficient the aramid aerogel obtained in Embodiments 1-13.

TABLE 1

| | Specific | Average pore | Thermal |
|---|---|---|---|
| | surface | diameter | conductivity |
| Embodiment | area/m²/g | of pores/nm | coefficient W/(m · K) |
| Embodiment 1 | 450 | 2.05 | 0.025 |
| Embodiment 2 | 425 | 3.03 | 0.028 |
| Embodiment 3 | 393 | 5.01 | 0.033 |
| Embodiment 4 | 370 | 5.51 | 0.041 |
| Embodiment 5 | 200 | 10.38 | 0.040 |
| Embodiment 6 | 390 | 5.05 | 0.034 |
| Embodiment 7 | 210 | 10.53 | 0.047 |
| Embodiment 8 | 220 | 10.34 | 0.045 |
| Embodiment 9 | 210 | 10.55 | 0.046 |
| Embodiment 10 | 200 | 10.35 | 0.047 |
| Embodiment 11 | 200 | 10.23 | 0.047 |
| Embodiment 12 | 210 | 10.55 | 0.045 |
| Embodiment 13 | 390 | 5.20 | 0.035 |

It might be seen from the above description that, in the above embodiments of the present disclosure, the following technical effects were realized.

The polyamide aerogel of the present disclosure was a porous material. The polyamide aerogel with a high porosity provided more adsorption surface area and volume, such that more active sites might be provided to the polyamide aerogel, thereby improving the adsorption capacity and catalytic activity of a material, and thus, the polyamide aerogel was suitable for air purification, wastewater treatment, and as a catalyst carrier. At an extremely low thermal conductivity (less than or equal to 0.048 W/(m·K)), in some embodiments, a thermal conductivity coefficient of the polyamide aerogel might even reach 0.025 W/(m·K), thereby facilitating insulation and heat preservation. Furthermore, the polyamide aerogel had a desirable structure and mechanical property and thus was more suitable for the fields of architecture, aerospace, and energy storage.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

What is claimed is:

1. A polyamide aerogel, wherein the polyamide aerogel is a porous material, a porosity of the polyamide aerogel is 90%-99%, and a thermal conductivity of the polyamide aerogel is less than or equal to 0.048 W/(m·K).

2. The polyamide aerogel according to claim 1, wherein a specific surface area of the polyamide aerogel is 200 m²/g-450 m²/g.

3. The polyamide aerogel according to claim 1, wherein an average pore diameter of pores of the polyamide aerogel is 1 nm-10 nm; and/or a density of the polyamide aerogel is 1 mg/cm³-50 mg/cm³.

4. A method for preparing the polyamide aerogel according to claim 1, comprising:
step S1, performing a complex reaction on a raw material comprising a polyamide slurry and a coordination crosslinking agent, to obtain a composite;
step S2, performing a gelation reaction on the composite and a gelation reagent, to obtain a gelation product;
step S3, performing a solvent displacement treatment on the gelation product, to obtain a polyamide wet gel; and
step S4, performing a drying treatment on the polyamide wet gel to obtain the polyamide aerogel.

5. The preparation method according to claim 4, wherein in step S1, a mass ratio of polyamide in the polyamide slurry to the coordination crosslinking agent is 1:0.032-0.8.

6. The preparation method according to claim 4, wherein polyamide in the polyamide slurry is aromatic polyamide, and/or the aromatic polyamide is selected from any one or more of poly(p-phenylene terephthamide), poly(m-phenylene isophthalamide), poly(p-benzamide), and polyphenylsulfone terephthalamide.

7. The preparation method according to claim 4, wherein in step S1, a temperature of the complex reaction is 5° C.-60° C.; and/or a time for the complex reaction is 0.3 h-33 h.

8. The preparation method according to claim 4, wherein the polyamide slurry comprises polyamide and a first solvent; and the first solvent is selected from any one or more of dimethyl sulfoxide, N,N-dimethylformamide, N,N-Dimethylacetamide, N,N-dimethylhexanamide, N-methylpyrrolidone, and triethyl phosphate.

9. The preparation method according to claim 8, wherein a solid content of the polyamide slurry is 1%-10%, and/or a pH value of the polyamide slurry is 4-7.

10. The preparation method according to claim 4, wherein in step S1, the coordination crosslinking agent comprises an inorganic copper salt and/or an inorganic nickel salt.

11. The preparation method according to claim 10, wherein in step S1, the inorganic copper salt is selected from any one or more of copper chloride, copper fluoride, and copper bromide.

12. The preparation method according to claim 10, wherein in step S1, the inorganic copper salt comprises an inorganic copper salt powder or an inorganic copper salt solution, the inorganic copper salt solution comprises an inorganic copper salt and a second solvent, and a mass ratio of the inorganic copper salt to the second solvent is 10-20:5-10.

13. The preparation method according to claim 10, wherein in step S1, the inorganic nickel salt is selected from any one or more of nickel chloride, nickel fluoride, and nickel bromide.

14. The preparation method according to claim 4, wherein in step S2, a temperature of the gelation reaction is 5° C.-60° C.; and/or a time for the gelation reaction is 3 h-30 h.

15. The preparation method according to claim 4, wherein in step S2, the gelation reaction is performed under a condition of high-speed shear dispersion, and a rotary speed of high-speed shear dispersion is 50 rpm-5000 rpm.

16. The preparation method according to claim 4, wherein in step S2, a solid content of the gelation product is 1%-10%.

17. The preparation method according to claim 4, wherein in step S2, the gelation reagent is selected from any one or more of water, an aqueous solution containing 20 wt. %-50 wt. % of N,N-dimethylacetamide, hydrochloric acid, sulfuric acid, ethanol, ethylene glycol, glycerol, acetone, tetrahydrofuran, chloroform, dichloromethane, and glacial acetic acid.

18. The preparation method according to claim 4, wherein in step S4, the drying treatment comprises performing vacuum freeze drying and/or vacuum drying on the polyamide wet gel; the vacuum freeze drying process comprises: performing temperature holding on the polyamide wet gel for 4 h-10 h at −40° C. to −20° C., and then under a vacuum condition, successively performing temperature holding for 4 h-10 h at −20° C. to −10° C., temperature holding for 4 h-10 h at −10° C. to 0° C., and temperature holding for 4 h-10 h at 0° C. to 10° C. on the polyamide wet gel, wherein the vacuum condition means that a gas pressure is less than 10 Pa.

19. The preparation method according to claim 18, wherein the vacuum drying process comprises: drying the polyamide wet gel for 6 h-10 h at 50° C.-80° C. and the gas pressure less than 10 Pa.

20. The preparation method according to claim 6, wherein the polyamide slurry is an aromatic polyamide slurry, the preparation method further comprises a process of preparing the aromatic polyamide slurry, and the preparation process comprises:
performing an amidation reaction on a raw material comprising aromatic diacyl chloride, aromatic diamine, and a fourth solvent, to obtain an aromatic amidation product;
performing a neutralization treatment on the aromatic amidation product by using an alkaline reagent, to obtain a neutralized product;
performing a dilution treatment on the neutralized product by using the fourth solvent, to obtain the aromatic polyamide slurry; or
dissolving polyamide in a fifth solvent to obtain the aromatic polyamide slurry.
